(19) United States
(12) Patent Application Publication
(10) Pub. No.: US 2003/0233621 A1
(43) Pub. Date: Dec. 18, 2003

(54) Editor for smart version control

(75) Inventors: Michael A. Paolini, Austin, TX (US); Eduardo N. Spring, Round Rock, TX (US); Michael John Walker, Austin, TX (US)

Correspondence Address: Robert H. Frantz, P.O. Box 23324, Oklahoma City, OK, 73123, US

(73) Assignee: International Business Machines Corporation, Armonk, NY (US)

(21) Appl. No.: 10/171,834

(22) Filed: Jun. 13, 2002

(51) Int. Cl. G06F 17/00

(52) U.S. Cl. 715/522

(57) ABSTRACT

An enhanced method and system for generating and editing source code such as web pages and software which is subject to information processing such as version control and differencing comparison. Formatted source code is first separated into effectual code and ineffectual style definitions. The effectual code can then be submitted to the information processor for processing based sole on effectual content, or may be preprocessed to apply a uniform style prior to submission to an information processor. In either case, a difference or comparison report of the new version of source code is devoid of format-based or format-triggered notices. For future editing of new source code versions, the author's style definitions may be applied to allow editing code which has the presentation desired by the author.

### BACKGROUND OF THE INVENTION

1. Field of the Invention

This invention relates to the arts of editors for programming and source code development, and to software version control systems and methods. This art also relates to the arts of creating information which is processed or analyzed by differencing engines, such as web pages and search engines, crawlers and spiders.

2. Background of the Invention

The tools available to computer programmers and software engineers have evolved through two general phases in the last 40 to 50 years. In the first phase, instructions for a computer were encoded on punch cards, with a deck of punch cards representing a program, routine, or subroutine. To create each card, a programmer would use a special console which loaded a blank (unpunched) card. The programmer could then use a keyboard to type instructions, which were then encoded onto the card by punching holes in certain locations on the card.

After a program or routine was completed, the programmer would have a deck of cards which contained instructions in a particular sequence representing the sequence and syntax of the programming language and the source code of the program. The deck of cards would then be loaded into a hopper where they would be read one-by-one into the computer's memory for later compilation into an executable program.

In the second phase of program creation tools, compilers which were capable of receiving flat text electronic files containing multiple sequences of software statements became widely used. A programmer may use one of many available text editors to create a source code file, which then could be input to the compiler for compiling and creation of an executable program. The source code file itself is a simple text file using encoding such as ASCII (American Standard Code for Information Interchange), wherein certain characters or codes are used to indicate soft line ends (e.g. “soft returns”), hard line ends (e.g. “hard returns”), and end of file. Certain codes or characters would represent “white space”, such as spaces and tabs. In general, each line of text in such a file represents one, two or four cards in the older method of creating source code.

To create a program using such a text editor, the user would need to be cognizant of two areas of syntax: (1) the syntax of the programming language, and (2) compiler directives compatible with the particular compiler to be used. In addition, for many older operating systems, computers, and programming languages, certain “platform dependent” instructions of a particular language may be unavailable for use depending on the targeted computer.

Some characters and strings of characters cause a compiler to ignore the text between them, such as “/*” and “*/” for comments, or “/1” in a first column to cause the entire line of the file to be ignored. These characters are useful for inserting comments into a source code file which are not to be interpreted as program statements.

To facilitate “readability” of source code so that one software designer may more readily understand the work of another software designer, many software coding “standards” have evolved which specify format (e.g. arrangement of the text) of source code. Most often, these “standards” are promulgated by a particular company within their own software development groups, oftentimes determined and maintained by a software quality assurance (“SQA”) or configuration control group. In other cases, a particular client or recipient of the code may specify certain coding standards, as is common with government and military software development projects.

For example, a particular software development company may require that each level of “nesting” or embedding of code into routines, subroutines, methods, functions, logic, etc., be represented by an additional 5 spaces from the left margin of the page. A sample of such a preferred format is shown in FIG. 5. In this figure, the column number (51) are given for reference in our illustration only, and are not usually present in an actual source code file.

This simple block of code for a function called “doSomething” (52) starts with a conditional statement (53). If the conditional statement is met, then the code between the first set of braces (54, 56) is executed, namely the function called “SomethingElse”. If the conditional statement (53) is not met, then the code between the second set of braces (58, 500) following the else statement (57) is executed, namely the function called “AThirdOption”.

This code and the format or arrangement of it is very readable, as each lower level or more dependent set of code is presented with a uniform indentation from the left margin and from the indentation level of the code which precedes it and upon which it depends.

Now, let's consider the code segment (60) of FIG. 6. In this arrangement of the same code of FIG. 5, much of the white space and line breaking has been eliminated such that the code (55) which is executed if the conditional statement (53) is met is co-located on the same line with the conditional statement itself. Also, the code (59) which is executed if the conditional statement (53) is not met is co-located on the same line with the “else” statement (57).

Both code fragments (50, 60) represent exactly the same logic with different presentations or styles. In one corporation, one format may be preferred, while in another corporation, the other format may be preferred. Further, one programmer may prefer the first format, while another programmer prefers the second format. There must be about as many “standard” formats as there are software development companies and software engineers, each with its own idiosyncrasies and advantages. For this reason, most compilers ignore such “white space”, and consider only the code (70) as it is shown in FIG. 7.

Turning now to FIG. 3, the well known process (30) of developing software is shown. First, a text editor (31) is used to produce a formatted source code file (32). This code includes the bare minimum text as required by the syntax rules of the particular programming language (e.g. C, Java, VisualBasic, etc.), as well as white space (e.g. spaces, tabs, line breaks, etc.) to achieve an appearance or format of the source code.

In a typical software development organization, this formatted source code file (32) is the “checked in” to a version control system (33), which first compares the source code to the previous version of the same file. If any differences in the new file are found, a list of differences is reported (35), including not only functional changes (e.g. changes which are logical differences to the program statements), but changes to the format as well (e.g. additional spaces, different line breaking, etc.). For the two code segments (50, 60) of FIGS. 5 and 6, a typical comparison routine would flag all 9 lines of code in FIG. 5 as having changed, assuming FIG. 5 is the earlier version of the software.

The software would then be released into a release library (34), from where it may be retrieved for the next build (e.g. compile and link) (36) of a new version of the executable code (37). When the software designer desires to change the source code again, he or she may “check out” (38) the file from the version control system, edit the code (31), and repeat the release cycle already discussed.

A problem lies in the comparison reports (35) which are generated by the version control system. As they typically include both logical changes and format changes in the report, a comparison report for a large portion of code may contain hundreds or even thousands of individual reports. Typically, the white space and formatting changes are of no consequence as they do not affect the actual compiled code (and functionality of the executable), but any interesting notices of changes to the logic of the code may be obscured by all of the format change notices, thus rendering the report itself of very little use.

A similar problem exists in other types of information processing technologies, such as the differencing engines employed by popular Internet search engines. For example, a particular web site may contain a page with the text shown in Table 1 initially when submitted to a search engine for indexing.

TABLE 1
Example Initial Web Page Text

<a href=“http://www.our_hobbies.com”>Please visit our new hobby
page!</a>

In this example using hyper text markup language (“HTML”), a hyperlink to a certain web address (e.g. www.our_hobbies.com) is associated with a displayable text string “Please visit our new hobby page!”. Table 2 shows a different version of the same HTML code, only with a different format or arrangement of the HTML.

TABLE 2
Example Variation Web Page Text

<a href=“http://www.our_hobbies.com”>
Please visit our new hobby page!
</a>

The HTML of Tables 1 and 2 will produce the exact same web page appearance when viewed with a web browser, as a web browser ignores white space which is only provided for formatting purposes, similar to a compiler ignoring such white space in a source code file. However, like some version control systems, some differencing processes for web search engines may detect the changes in the two HTML code segments, and flag the web page as changed. This may unnecessarily trigger re-indexing of the page, re-crawling of the site, etc.

This text-based system of developing certain types of computer software and data items remains prevalent today, despite the issues and problems just discussed. Therefore, there is a need in the art for a system and method which allows software code developers to develop code with a preferred format, but which avoids the creation of format-based change reports or format-triggered actions. Preferably, this new system and method would be compatible with existing software and electronic file development tools and techniques, as well as compatible with existing version control systems, compilers, and differencing engines.

### BRIEF DESCRIPTION OF THE DRAWINGS

The following detailed description when taken in conjunction with the figures presented herein provide a complete disclosure of the invention.

FIG. 1 depicts a generalized computing platform architecture, such as a personal computer, server computer, personal digital assistant, web-enabled wireless telephone, or other processor-based device.

FIG. 2 shows a generalized organization of software and firmware associated with the generalized architecture of FIG. 1.

FIG. 3 shows the prior art process of editing source code, checking it into a version control system, generating comparison reports, and checking out for additional revisions.

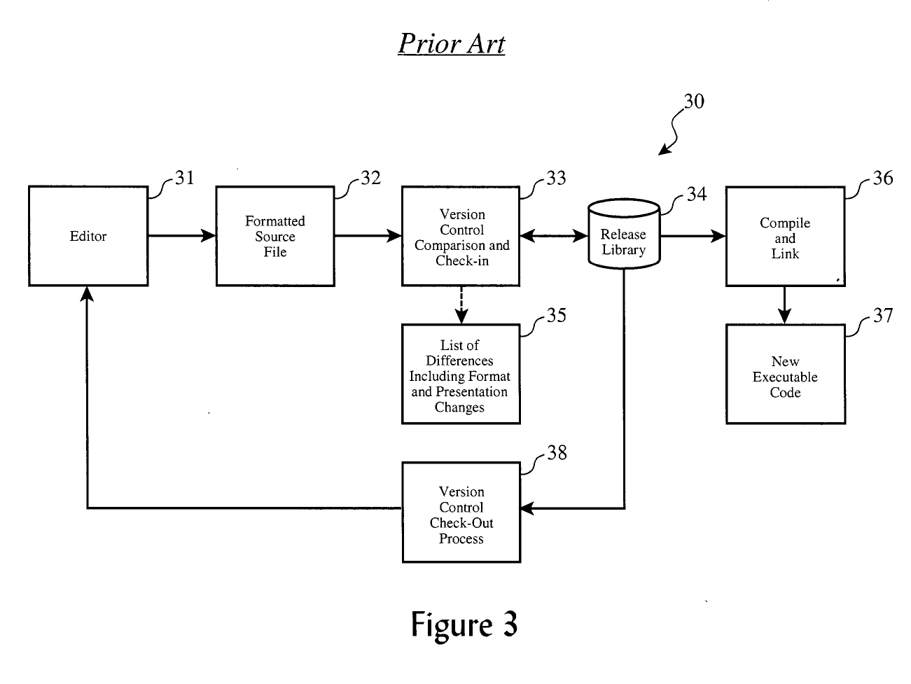

FIG. 4 shows the logical process of the invention.

FIG. 5 provides one example of source code with a first format or style.

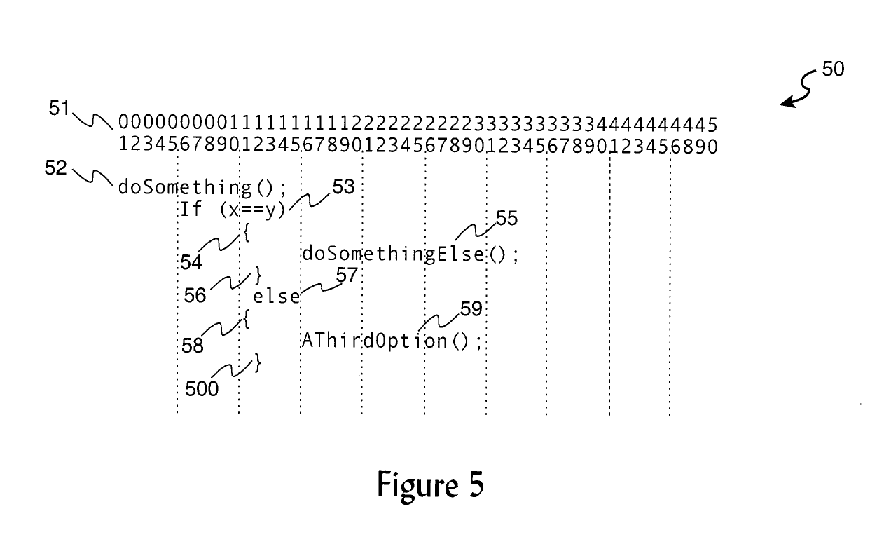

FIG. 6 provides one example of source code with a second format or style.

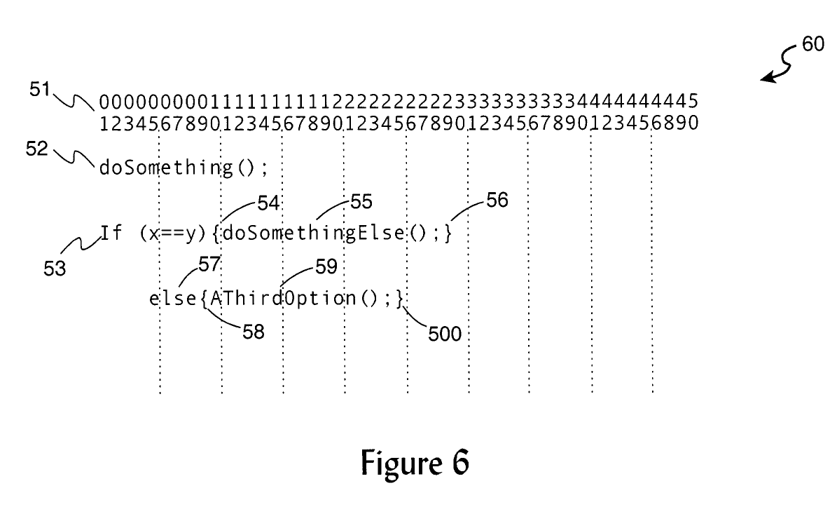

FIG. 7 provides one example of source code with a third format or style.

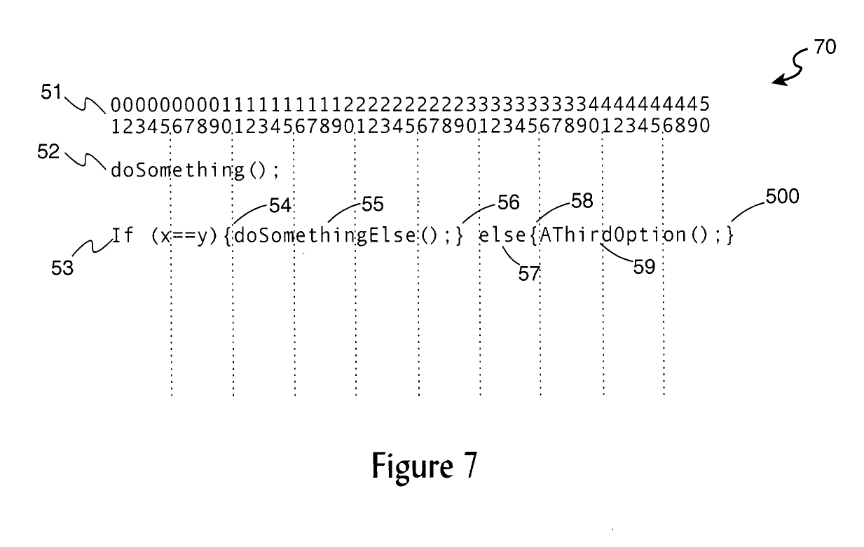

### SUMMARY OF THE INVENTION

The present invention applies newer document technologies, such as Extensible Markup Language (“XML”) and Hyper Text Markup Language (“HTML”) with Cascading Style Sheets (“CSS”), to allow content-driven format-independent information processing, and especially to software source code development and version control, as well as to web page content and differencing engines.

Our solution adopts the XML and HTML/CSS mantra of separating style or presentation format from actual content. Recognizing that white space outside of comment strings and strings have no meaning or effect in most modern programming languages, the present invention provides several methods to minimize the impact on differencing and version controls systems, while allowing reformatted display for editors.

In a first aspect of the invention, source files which usually consists of formatted text are separated into style descriptors and pure content files, depending on the syntax of the language being used. For example, if a software engineer is developing a program in “C”, the syntactical rules for the “C” language are used to determine what text in the file is effectual (or “content”) for the logic of the program, and the rest of the characters and codes in the file are deemed to be “style” definitions. Such things as white space, including but not limited to tabs, indents, spaces, etc., as well as line and page breaks may be ineffectual for the compiling of the “C” program, and would be considered style, instead. The same method can be applied to the original source text file of HTML web pages, as well, except the syntax rules of HTML would be applied to determine which characters and codes were effectual content, and which were ineffectual style.

The content file and the style descriptors are then processed separately by the information processor which is content-sensitive, such as a software version control system check in comparison process or a web page differencing engine for a web search engine. This allows the information processor to consider only effectual changes to the data item being processed, such as actual code changes which will result in logical program changes in a compiled software product, or such as actual content differences which appear in a new version of a web page.

In another aspect of the present invention, each party involved in the software or code development cycle (e.g. developers, SQA, customers and clients, etc.) may receive code in the format or style they prefer while effectively managing the content of the code. As the content and style of the code as maintained separately according to the invention, reviewers and future editors of a particular data item may apply a preferred style descriptor to the content-only file in order to view and edit the code in a preferred format.

This allows the same content to be viewed in any number of preferred formats, and resolves long-standing issues with enforcing a single format on a population of developers who each prefer a different format or style. As such, a corporation or client could have a preferred format which is defined by a first style descriptor and which is applied to content prior to delivery of code to the corporate release library, or which is applied prior to delivery to a client. Each developer, though, could have his or her own preferred style descriptor, which is applied to the content whenever he or she is reviewing or editing the code, thereby allowing them to be more productive while working in an code environment in which they are most accustomed or comfortable.

### DETAILED DESCRIPTION OF THE INVENTION

This invention is preferrably realized as methods and processes implemented in software in conjunction with a computing platform, such as software functionality extensions to software development version control systems running on a software configuration control library server, or differencing engines for web search engines running on networked web servers. Therefore, it is useful to first review the general architecture of a computing platform which may be employed in conjunction with the specific processes of the invention.

The invention is preferably realized as a feature or addition to the software already found present on well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

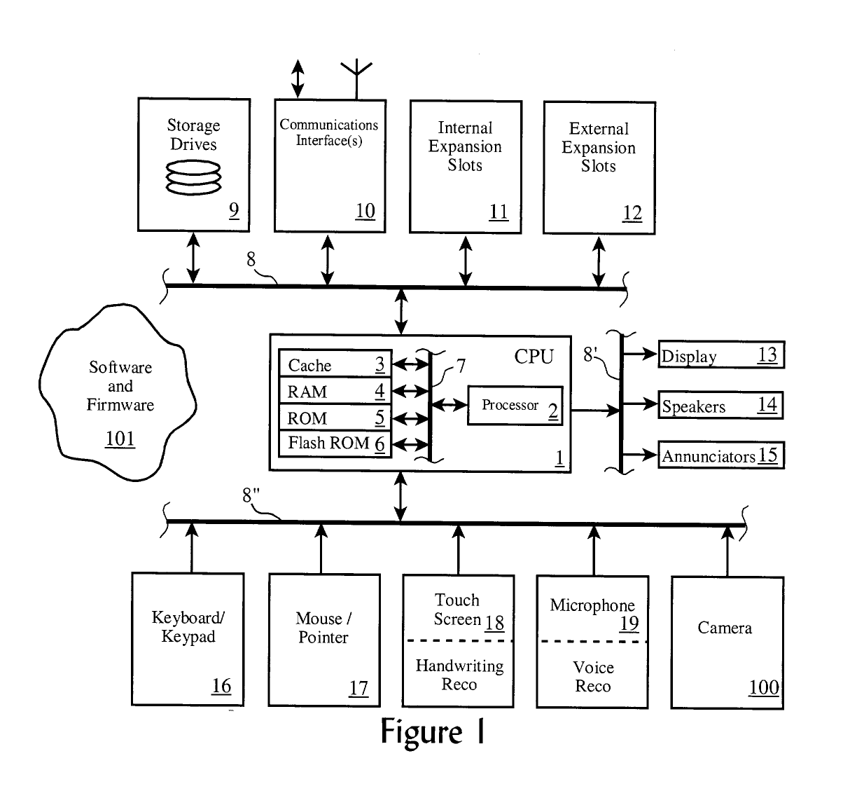

Turning to FIG. 1, a generalized architecture is presented including a central processing unit (1) (“CPU”), which is typically comprised of a microprocessor (2) associated with random access memory (“RAM”) (4) and read-only memory (“ROM”) (5). Often, the CPU (1) is also provided with cache memory (3) and programmable FlashROM (6). The interface (7) between the microprocessor (2) and the various types of CPU memory is often referred to as a “local bus”, but also may be a more generic or industry standard bus.

Many computing platforms are also provided with one or more storage drives (9), such as a hard-disk drives (“HDD”), floppy disk drives, compact disc drives (CD, CD-R, CD-RW, DVD, DVD-R, etc.), and proprietary disk and tape drives (e.g., lomega Zip [TM] and Jaz [TM], Addonics SuperDisk [TM], etc.). Additionally, some storage drives may be accessible over a computer network.

Many computing platforms are provided with one or more communication interfaces (10), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (11), such as Industry Standard Architecture (ISA), Enhanced Industry Standard Architecture (“EISA”), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (12) allowing the user the ability to easily install and remove hardware expansion devices, such as PCMCIA cards, SmartMedia cards, and various proprietary modules such as removable hard drives, CD drives, and floppy drives.

Often, the storage drives (9), communication interfaces (10), internal expansion slots (11) and external expansion slots (12) are interconnected with the CPU (1) via a standard or industry open bus architecture (8), such as ISA, EISA, or PCI. In many cases, the bus (8) may be of a proprietary design.

A computing platform is usually provided with one or more user input devices, such as a keyboard or a keypad (16), and mouse or pointer device (17), and/or a touch-screen display (18). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (18) is usually provided, often with handwriting recognition capabilities.

Additionally, a microphone (19), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (100), such as a still digital camera or full motion video digital camera.

One or more user output devices, such as a display (13), are also provided with most computing platforms. The display (13) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (14) and/or annunciators (15) are often associated with computing platforms, too. The speakers (14) may be used to reproduce audio and music, such as the speaker of a wireless telephone or the speakers of a personal computer. Annunciators (15) may take the form of simple beep emitters or buzzers, commonly found on certain devices such as PDAs and PIMs.

These user input and output devices may be directly interconnected (8′, 8″) to the CPU (1) via a proprietary bus structure and/or interfaces, or they may be interconnected through one or more industry open buses such as ISA, EISA, PCI, etc.

The computing platform is also provided with one or more software and firmware (101) programs to implement the desired functionality of the computing platforms.

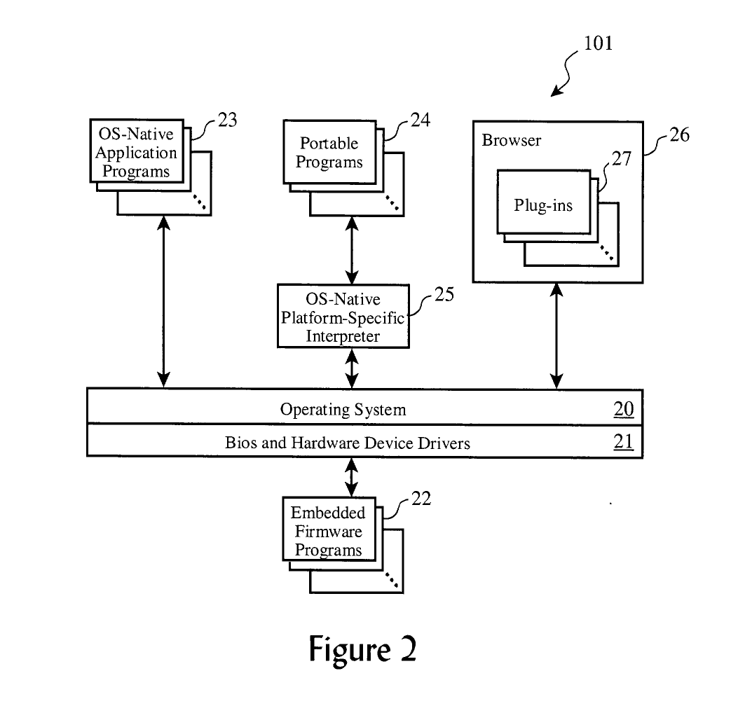

Turning to now FIG. 2, more detail is given of a generalized organization of software and firmware (101) on this range of computing platforms. One or more operating system (“OS”) native application programs (23) may be provided on the computing platform, such as word processors, spreadsheets, contact management utilities, address book, calendar, email client, presentation, financial and bookkeeping programs.

Additionally, one or more “portable” or device-independent programs (24) may be provided, which must be interpreted by an OS-native platform-specific interpreter (25), such as Java [TM] scripts and programs.

Often, computing platforms are also provided with a form of web browser or micro-browser (26), which may also include one or more extensions to the browser such as browser plug-ins (27).

The computing device is often provided with an operating system (20), such as Microsoft Windows [TM], UNIX, IBM OS/2 [M], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 1 and 2 describe in a general sense the various hardware components, software and firmware programs of a wide variety of computing platforms, including but not limited to personal computers, PDAs, PIMs, web-enabled telephones, and other appliances such as WebTV [TM] units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

We now turn our attention to description of the methods of the invention and it's associated components, which are preferrably realized as independent software products (e.g. software version check-in preprocessors) or as extensions to existing software products (e.g. version control systems, web search engines, etc.).

According to the invention, several fundamental approaches are provided or supported. First, editing style may be enforced at the version control system level, by:

(a) enforcing a particular style by the version control system at upon check-in of the code; or

(b) the editing style may be identified (not enforced) at the time of check in by a version control system so that it can be used for comparison in subsequently checked in code.

In the first method where the style is enforced upon check in of code, the version control system contains a “standard” editing style, which may be customizable or changeable only by an authorized system administrator. Everytime a formatted source code file is checked-in, regardless of its editing style, it will be saved using version control system's standard editing style.

In the other variation of this method, the editing style of the checked in file is identified by the version control system during the original or initial check-in, and an editing scheme is created for that particular file. The version control system then associates this style to that file every time a new version of the file is checked-in, and this style is enforced by version control system.

For other types of information processing, such as differencing engines, these two variations of the method of the invention may be adopted appropriately at the information processing system level, such as at the differencing engine and submission engine level for a web search engine.

In a first alternative embodiment of the invention, the editing style is enforced at the editor level instead of at the information processing level (e.g. at the source code editing level instead of at the information processing system level). In this approach, a preferred style is applied by the editor at the time of saving a new source code file, and upon opening a check out source code file. The editor software preferrably scans the loaded (opened) file, finds the closest match for style, and applies it to the checked out file. If a style match cannot be found, preferably the editor program creates a new style descriptor and prompts the user for confirmation. Subsequently, this style is applied every time a save is performed on that file, and everytime a this file is check out from the version control system.

In a second alternative embodiment of the method of the invention, style of a data item is separated from the file either at version control system or editor level by removing all ineffectual characters and codes (e.g. white space, tabs, spaces, line breaks, page breaks, etc.) before the file is saved in a repository or otherwise processed by the information processing system.

As such, several prevalent document standards are available in the art today for adoption into the method of the invention: Standard Generalized Markup Language (“SGML”), Extensible Markup Language (“XML”) and Hyper Text Markup Language (“HTML”). With the broader SGML, a document type definition (“DTD”) file serves as a style descriptor, which specifies which markup codes are used to indicate format or presentation options, such as tabs, bolding, headings, etc.

XML and HTML are subsets of SGML, as defined by their own DTD's. Additionally, one or more cascading style sheets (“CSS”) may be utilized with HTML or XML documents or files to apply style preferences and definitions. A CSS provides definition and control over the appearance of a document. Certain precedence rules are applied in the processing of CSS definitions and controls, such that a creator or owner of a document can allow or disallow a viewer to override style definitions with the viewer's own style preferences. This is useful in some manners of enforcement, such as defining a version control system as being the “owner” of a checked out file, and allowing only certain stylistic changes to the file by the developer who checks out the file.

SGML, HTML, XML, CSS and DTD are all well known in the art. They are adopted in our preferred embodiment because editors are readily available for these standard types of data and document files. However, it will be recognized by those skilled in the are that other techniques and technologies for maintaining separate content and style descriptors may be adopted without departing from the spirit and scope of the present invention.

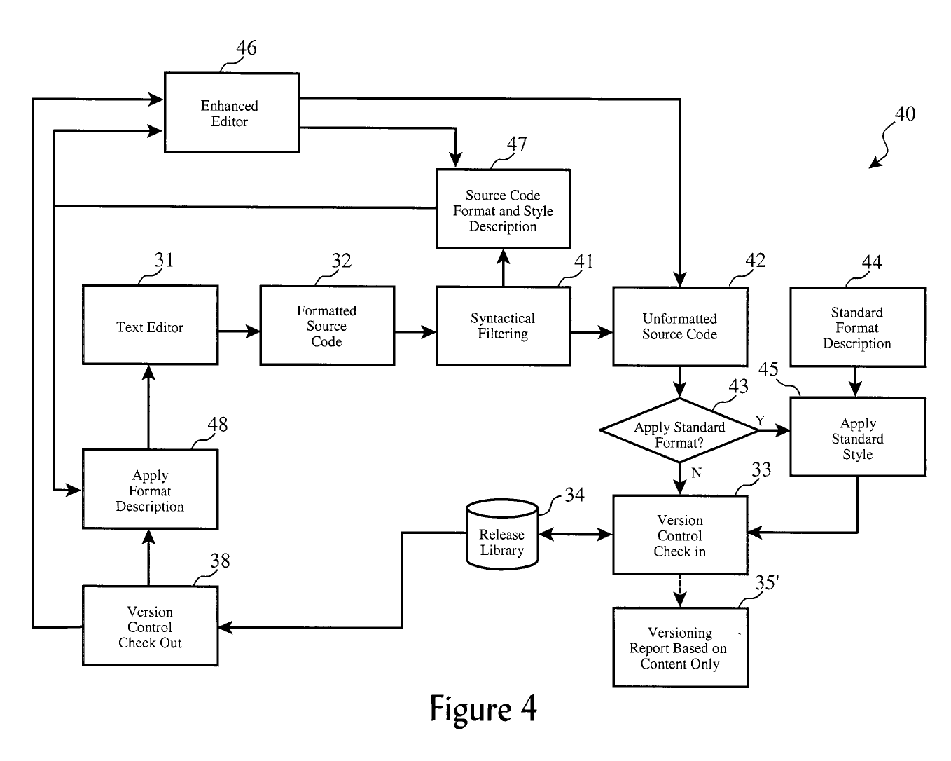

Turning now to FIG. 4, a generalized and consolidated illustration of the logical process (40) of the invention is provided. This consolidated illustration includes the functionality for all of the preferred and alternate embodiments previously described, and as such, not all portions of the illustration must be realized in order to implement a particular embodiment of the invention.

Starting with an traditional text editor (31), a code developer may create formatted source code (32) (software, HTML, etc.) as he or she has previously done. However, prior to submitting the formatted source code (32) to an information processing system such as a version control system or differencing engine, syntactical filtering is performed (41) wherein a specific set of syntax rules are applied to separate content from style in the formatted source code (32). If, for example, the source code is a Java language program, the syntax rules of Java would be used to determine which characters and codes within the formatted source code (32) are effectual or content, and which are present purely for format, presentation or style purposes.

The syntactical filtering (41) produces unformatted source code (42) (e.g. primarily effectual content) and a style or format descriptor (47). Depending on the variation of embodiment realized, the syntactical filtering may be performed by the editor upon saving of the source code file (e.g. exporting or publishing to separate style and content files), may be performed subsequent to saving and prior to submitting to the information processing system (e.g. by a content/style separating utility), or upon submission to the information processing system (e.g. as a preprocess to version control check in or a preprocess to a differencing engine).

Alternatively, if an enhanced editor (46) is available which directly outputs or exports the desired content and style-based files, such as an editor capable of creating XML with CSS, the style descriptor (47) and unformatted source code (42) may be rendered directly from the enhanced editor (46).

Next, the unformatted source code (42) may optionally (43) be modified by applying (45) a standard style descriptor (44) in order to “enforce” a standard style. Again, this application of a standard style may be done upon submission to the information processing system, upon output from the editor, or at an intermediate step by a utility program.

In this manner, the code which reaches the information processing system, such as a version control system check in process (33) or web search engine differencing process (not shown), can be compared based upon effectual content only, thereby allowing an enhanced versioning or difference report (35′) to be generated which is devoid of style-based difference notices. This report can then be more readily evaluated by the code developer, SQA engineer, or client to determine exactly what functional changes have been made to the newly checked in code.

If the changes are acceptable, then the new code (in its unformatted state or its standard style state) may be promoted to the release library (34), indexed for search results, or otherwise processed to a released, in-use, or acceptable state.

For subsequent revision of the code, a developer may check out the code from the version control checkout (38) process. Optionally, the developer's preferred style descriptor (47) may be applied (48) to the checked out code prior to editing so that he or she may work in a coding environment where they feel most comfortable and productive. The application (48) of the developer's preferred style descriptor (47) may be performed by the version control check out process, by the editor's file loading or opening process, or by an intermediate utility program. If an enhanced editor (46) such as a SGML or XML editor is being used, the application of the preferred style may be performed within the editor's functionality.

If the code is being checked out (34) for delivery to a specific client, the client's preferred style descriptor may be applied. This enables one set of source code to be readily “repurposed” for delivery to a variety of clients, each of whom have a different style preference, without the need to develop the source code in multiple styles or formats. This, in turn, reduces the number of reduced code modules which are equivalent in functionality, but different in style, which allows for minimized quality testing and configuration control.

As several example embodiments, specific aspects of a preferred embodiment and alternative embodiments have been disclosed, it will be recognized by those skilled in the art that some variations may be made without departing from the spirit and scope of the present invention, including but not limited to adoption of other programming or coding languages and methodologies, use of alternate computing platforms, and application of the method to other types of information processing systems. Therefore, the scope of the present invention should be determined by the following claims.

What is claimed is:

1. A method for improved electronic information version control processing, said processing being done by an information processing system which provides a comparison or difference report based upon information provided to the information processing system, said method comprising the steps of:
separating formatted source code into unformatted effectual source code and a format descriptor through syntactical filtering such that said unformatted source code is devoid of ineffectual source code;
submitting said effectual source code to said information processing system; and
receiving a comparison or difference report from said information processing system which is devoid of difference notices based upon ineffectual source code.

2. The method as set forth in claim 1 further comprising the step of applying a preferred format descriptor to said unformatted effectual source code prior to submitting it to said information processing system, thereby allowing processing of source code in a uniform style and continuing to provide difference reports which are devoid of difference notices based upon ineffectual source code.

3. The method as set forth in claim 1 wherein said step of separating formatted source code into unformatted effectual source code and a format descriptor through syntactical filtering is performed by a source code editor.

4. The method as set forth in claim 1 wherein said step of separating formatted source code into unformatted effectual source code and a format descriptor through syntactical filtering is performed by an information processing system preprocessor.

5. The method as set forth in claim 4 wherein said step of separation is performed by a software version control check in process.

6. The method as set forth in claim 4 wherein said step of separation is performed by a search engine differencing process.

7. A computer readable medium encoded with software for providing improved electronic information version control processing, said processing being done by an information processing system which provides a comparison or difference report based upon information provided to the information processing system, said software causing a computing platform to perform the steps of:
separating formatted source code into unformatted effectual source code and a format descriptor through syntactical filtering such that said unformatted source code is devoid of ineffectual source code;
submitting said effectual source code to said information processing system; and
receiving a comparison or difference report from said information processing system which is devoid of difference notices based upon ineffectual source code.

8. The computer readable medium as set forth in claim 7 further comprising software for performing the step of applying a preferred format descriptor to said unformatted effectual source code prior to submitting it to said information processing system, thereby allowing processing of source code in a uniform style and continuing to provide difference reports which are devoid of difference notices based upon ineffectual source code.

9. The computer readable medium as set forth in claim 7 wherein said software for separating formatted source code into unformatted effectual source code and a format descriptor through syntactical filtering comprises software associated with a source code editor.

10. The computer readable medium as set forth in claim 7 wherein said software for separating formatted source code into unformatted effectual source code and a format descriptor through syntactical filtering comprises software associated with an information processing system preprocessor.

11. The computer readable medium as set forth in claim 10 wherein said software for separation is associated with a software version control check in process.

12. The computer readable medium as set forth in claim 10 wherein said software for separation is associated with a search engine differencing process.

13. A source code generation system for allowing improved electronic information version control processing, said processing being done by an information processing system which provides a comparison or difference report based upon information provided to the information processing system, said source code generation system comprising:
a syntactical filter for a separating formatted source code into unformatted effectual source code and a format descriptor such that said unformatted source code is devoid of ineffectual source code;
a submitter for submitting said effectual source code to said information processing system; and
a means for receiving a comparison or difference report from said information processing system which is devoid of difference notices based upon ineffectual source code.

14. The system as set forth in claim 13 further comprising a preferred format descriptor applicator for applying a preferred format descriptor to said unformatted effectual source code prior to submitting it to said information processing system, thereby allowing processing of source code in a uniform style and continuing to provide difference reports which are devoid of difference notices based upon ineffectual source code.

15. The system as set forth in claim 13 wherein said syntactical filter is an integral component of a source code editor.

16. The system as set forth in claim 13 wherein said syntactical filter is an integral component of an information processing system preprocessor.

17. The system as set forth in claim 16 wherein said syntactical filter is cooperative with a software version control check in process.

18. The system as set forth in claim 16 wherein said syntactical filter is cooperative with a search engine differencing process.
